(19) United States
(12) Patent Application Publication
(10) Pub. No.: US 2009/0111575 A1
(43) Pub. Date: Apr. 30, 2009

(54) SYSTEM AND METHOD FOR PROVIDING BETTING GAME VIA COMMUNICATION NETWORK

(76) Inventor: Jung-Ja Kim, Muan-Gun Jeollanam-Do (KR)

Correspondence Address: IPLA P.A., 3580 WILSHIRE BLVD., 17TH FLOOR, LOS ANGELES, CA, 90010, US

(21) Appl. No.: 12/301,730

(22) PCT Filed: May 17, 2007
(86) PCT No.: PCT/KR2007/002402

§ 371 Date: Nov. 20, 2008

(30) Foreign Application Priority Data
May 22, 2006 (KR) 10-2006-0045656
May 17, 2007 (KR) PCT/KR2007/002402

(51) Int. Cl. A63F 9/24; A63F 13/00

(52) U.S. Cl. 463/25; 463/42; 463/43

(57) ABSTRACT

Provided is a system for providing a betting game via a communication network. A game operation unit sequentially provides at least one user terminal accessing a communication network with a game selection screen, a game waiting screen, a gaming screen, and a game result screen. A dividend calculation unit calculates the dividend to be given to each participant selecting the selection object corresponding to the game mission, on the basis of the sum of bet amounts and the number of participants selecting the selection object corresponding to the game mission. A storage unit stores screen configuration information of the betting game, betting values, and the number of participants and the bet amount of the betting game.

### TECHNICAL FIELD

The present invention relates to a system and method for providing a betting game via a communication network, and more particularly, to a system and method for providing a betting game to a terminal connected to a communication network such as the wired/wireless Internet, a mobile communication network, and a digital broadcast network.

### BACKGROUND ART

A betting game is played in association with a main game, such as a horse racing. In the betting game, viewers bet on a result of a main game and receive a dividend according to the result of the main game after the main game is finished. With the advance of communication networks including the Internet, betting games can be played via the communication network. A representative example of such a betting game may include an Internet horse-racing betting game. To play the Internet horse-racing betting game, a user accesses a horse racing site and bets on a horse to win. After the horse race is finished, the user receives a dividend according to a dividend rate calculated on the basis of a betting information database including betting information.

However, since the betting game is provided in association with a main game, participants of the game must wait until the main game is over. Also, since the dividend rate is determined by the result of the main game, the participants must continuously obtain separate information on the main game, such as past performance records or current conditions of horses, which functions to limit the number of game participants. Furthermore, since the betting game is dependent on the main game, diversity of the betting game is limited.

### DISCLOSURE OF INVENTION

### Technical Problem

The present invention provides a system and method for providing a betting game via a communication network, which are configured to promptly provide game participants with a betting result and can increase its application range.

The present invention also provides a computer-readable recording medium storing a program for executing a method for providing a betting game via a network communication network, which is configured to promptly provide game participants with a betting result and can increase its application range.

### Technical Solution

According to an exemplary embodiment, a system for providing a betting game via a communication network includes a game operation unit, a dividend calculation unit, and a storage unit. The game operation unit is configured to provide at least one user terminal accessing a communication network with one or more of a game selection screen, a game waiting screen, a gaming screen, and a game result screen. The game selection screen includes a plurality of selection buttons for allowing the user to select betting games classified according to a betting base amount. The game waiting screen is provided when a user of the user terminal selects a desired betting game. The game waiting screen includes a game mission set for the selected betting game, a remaining time until a game start point, a total number of participants participating in the betting game until the point when the user selects the betting game, and a total bet amount wagered until the point when the user selects the betting game. The gaming screen is provided when the remaining time until the game start point expires. The gaming screen includes a remaining time until a game end point, and a plurality of selection objects, each of which includes identification information. The game result screen is provided when the remaining time until the game end point expires. The game result screen includes a total number of participants, the total bet amount, the selection object selected by the user, a number of participants that have selected each of the selection objects, and a dividend to be given to each participant who has selected the selection object corresponding to the game mission. The dividend calculation unit is configured to calculate the dividend to be given to each participant who selects the selection object corresponding to the game mission, on the basis of the sum of bet amounts wagered by the total number of participants of the betting game, and the number of participants selecting the selection object corresponding to the game mission. The storage unit is configured to store screen composition information of the betting game, identification information of the selection objects selected by the participants of the betting game, the identification information of the selection objects corresponding to identification information of the respective participants who select the corresponding selection objects, and the number of participants and the total bet amount of the betting game.

According to another exemplary embodiment, a system for providing a betting game via a communication network includes: a game operation unit configured to provide a broadcasting signal transmitter with game information about a betting game, the game information comprising a plurality of selection objects, a participation period, and an automatic response service (ARS) number, to receive identification information of the selection objects selected by one or more participants accessing an ARS system corresponding to the ARS number using wired/wireless communication devices within the participation period, and to provide the broadcasting signal transmitter or the wired/wireless communication devices of the respective participants with game result information when the participation period expires, the game result information comprising the total number of participants of the betting game, the total bet amount, the number of participants selecting the selection objects, and a dividend to be given to each participant selecting the selection object corresponding to the game mission; a dividend calculation unit configured to calculate the dividend to be given to each participant selecting the selection object corresponding to the game mission on the basis of the sum of bet amounts wagered by the participants of the betting game, and the number of participants selecting the selection object corresponding to the game mission; and a storage unit configured to store game information of the betting game, identification information of the selection objects selected by the participants of the betting game, the identification information of the selection objects being in connection with identification information of the respective participants selecting the corresponding selection objects, and the total number of participants and the total bet amount of the betting game.

According to yet another exemplary embodiment, a method for providing a betting game via a communication network includes: providing at least one user terminal accessing a communication network with a game selection screen for allowing a user to select betting games classified according to a betting base amount; providing the user terminal with a game waiting screen when a user of the user terminal selects a desired betting game, the game waiting screen comprising a game mission set for the betting game selected by the user, a remaining time until a game start point, the total number of participants participating in the betting game until the point when the user selects the betting game, and the total bet amount wagered until the point when the user selects the betting game; providing the user terminal with a gaming screen when the remaining time until the game start point expires, the gaming screen comprising a remaining time until a game end point, and a plurality of selection objects each having identification information; calculating a dividend to be given to each participant selecting the selection object corresponding to the game mission on the basis of the sum of bet amounts wagered by participants of the betting game, and the number of participants selecting the selection object corresponding to the game mission, when the remaining time until the game end point expires; and providing the user terminal with a game result screen when the time reaches the game end point, the game result screen comprising the total number of participants, the total bet amount, the selection object selected by the user, the numbers of participants selecting each of the selection objects, and the dividend to be given to each participant selecting the selection object corresponding to the game mission.

According to still another exemplary embodiment, a method for providing a betting game via a communication network includes: providing a broadcasting signal transmitter with game information of a betting game, the game information comprising a plurality of selection objects, a participation period, and an automatic response service (ARS) number; receiving identification information of the selection objects selected by one or more participants accessing a ARS system corresponding to the ARS number using wired/wires communication devices within the participation period; calculating a dividend to be given to each participant selecting the selection object corresponding to the game mission on the basis of the sum of bet amounts wagered by the participants of the betting game, and the number of participants selecting the selection object corresponding to the game mission, when the participation time expires; and providing the broadcasting signal transmitter or the wired/wireless communication devices of the respective participants with game result information when the participation time expires, the game result information comprising the total number of participants of the betting game, the total bet amount, the numbers of participants selecting each of the selection objects, and the dividend to be given to each participant selecting the selection object corresponding to the game mission.

Accordingly, the betting result can be promptly provided to the game participants, and the betting game can be applied to various fields, for example, an opinion survey and preference researches. Hence, the betting game according to the present invention can create new profits.

### ADVANTAGEOUS EFFECTS

According to a system and method for providing a betting game according to exemplary embodiments of the present invention, game participants can be provided with a betting result at the moment that a betting game is over, and a betting game can be independently operated because the game result is determined according to selections of game participants. Hence, the betting game can create profits by applying to various fields, for example, an opinion survey or a preference research.

### BRIEF DESCRIPTION OF THE DRAWINGS

FIG. 1 illustrates a configuration of a network including a system for providing a betting game according to an exemplary embodiment.

FIG. 2 is a block diagram of a detailed configuration of the system illustrated in FIG. 1.

FIG. 3 illustrates a game selection screen displayed on a user terminal according to an exemplary embodiment.

FIG. 4 illustrates a game waiting screen according to an exemplary embodiment.

FIG. 5 illustrates a gaming screen displayed on a participant terminal according an exemplary embodiment.

FIG. 6 illustrates a game result screen according to an exemplary embodiment.

FIG. 7 is a flowchart illustrating a method for providing a betting game according to an exemplary embodiment.

FIG. 8 is a flowchart illustrating a method for providing a betting game according to another exemplary embodiment.

### MODE FOR THE INVENTION

Hereinafter, specific embodiments will be described in detail with reference to the accompanying drawings.

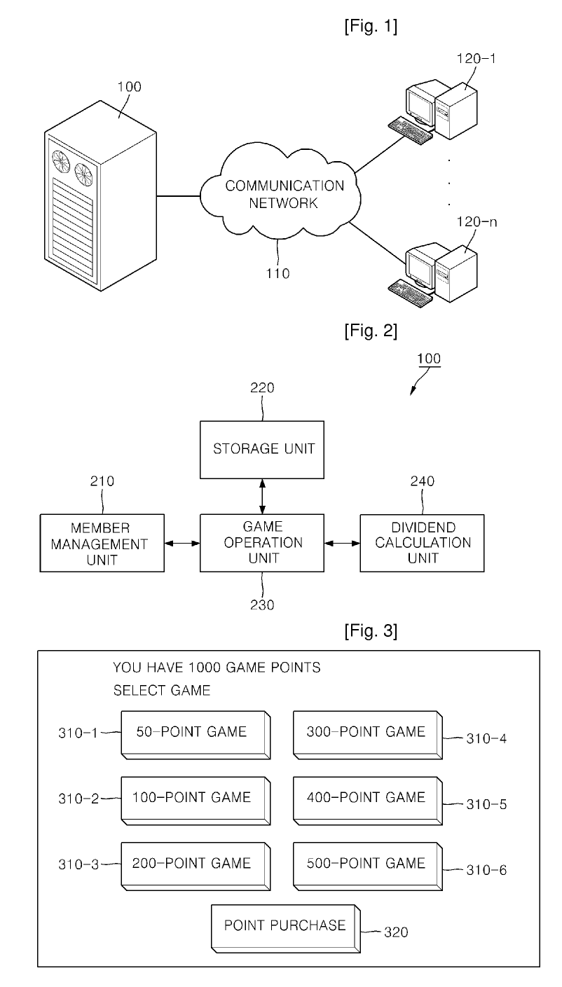

FIG. 1 illustrates a configuration of a network including a system for providing a betting game according to an exemplary embodiment.

Referring to FIG. 1, the network includes a betting-game providing system 100, a communication network 110, and a plurality of user terminals 120-1 to 120-n.

The betting-game providing system 100 is configured to provide one or more game participants with a betting game via the communication network 110. The betting-game providing system 100 is configured to perform a member management/access authentication function, a game operation function, a betting-information management function, and a dividend calculation function. Other functions of the betting game may be performed by the betting-game providing system 100 or may be performed by a separate device connected to the betting-game providing system 100 via the communication network 110 on the basis of data provided from the betting-game providing system 100.

The communication network 110 is configured to provide data exchange paths between a variety of remote terminals, such as Public Switched Telephone Network (PSTN), wired/wireless Internet, and mobile communication network. A data path from the betting-game providing system 100 to the user terminals 120-1 to 120-n and a data path from the user terminals 120-1 to 120-n to the betting-game providing system 100 may be formed via different kinds of communication networks. The user terminals 120-1 to 120-n access the betting-game providing system 100 via the communication network 110, and receive information from the users or output data received from the betting-game providing system 100 to the users. To this end, a dedicated game program using ActiveX or Java, which is provided by the betting-game providing system 100, is installed in each user terminal 120-1 to 120-n. The game-dedicated program installed in the user terminals 120-1 to 120-n includes a game management module and a program update module. The game management module is configured to perform a waiting-time counting function, a game-time counting function, an update function of updating the total number of users (i.e., participants) participating in the game, and an update function of updating the total amount of prize money. The program update module is configured to perform an update function associated with version-up of the dedicated game program. The user terminals 120-1 to 120-n may be a device connected to the communication network 110 such as the PSTN, the wired/wireless Internet, and the mobile communication network, to provide data communications. Examples of the user terminals 120-1 to 120-n may include wired telephones, wireless telephones, personal digital assistants (PDAs), computers, and notebook computers. Also, the digital broadcast network may be used as the communication network 110 in the digital broadcasting environment which broadcast and communication are being merged. In this case, TV sets serve as the user terminals 120-0 to 120-n.

FIG. 2 is a block diagram illustrating a detailed configuration of the betting-game providing system of FIG. 1.

Referring to FIG. 2, the betting-game providing system 100 according to an exemplary embodiment includes a member management unit 210, a storage unit 220, a game operation unit 230, and a dividend calculation unit 240.

The member management unit 210 manages member information of members of services offered by a company, which operates the betting-game providing system 100, or a company, which cooperates with the provider operating the betting-game providing system 100. Also, the member management unit 210 processes a member joining process of game participants and performs member authentication. Since technologies associated with the member-joining processing and the member authentication are well known to those skilled in the art, their detailed description will be omitted.

The storage unit 220 stores member information, game information, dividend information, and so on. The member information includes a member ID, a password, contact information, game points that a member has, and so forth. The game information includes information of each game provided from the betting-game providing system 100, for example, a main screen of a game, a set value such as a betting value, a game operating program, and game operation information. Also, the dividend information includes the number of participants in each game, and the total bet amount, i.e., the total amount wagered on the game by the participants.

The game operation unit 230 transmits a gaming screen indicating a game operation status to the user terminals 120-1 to 120-n accessing the betting-game providing system 100 via the communication network 110. When the users access the betting-game providing system 100 by using their own terminals 120-1 to 120-n and the member management unit 210 authenticates the access of the users, the game operation unit 230 transmits a game selection screen to the user terminals 120-1 to 120-n. FIG. 3 illustrates the game selection screen displayed on the user terminals 120-1 to 120-n according to an exemplary embodiment. Referring to FIG. 3, the game selection screen includes a plurality of selection buttons 310-1 to 310-6 for allowing the users to select betting games that are offered by the betting-game providing system 100 and are classified according to a betting base amount, and a point purchase button 320. Also, the game selection screen includes game points of the authenticated user.

When the participant selects a specific betting game, the game operation unit 230 checks whether the game points of the participant are more than a minimum betting base amount of the selected betting game. If the game points of the participant are less than the minimum betting base amount of the selected betting game, the game operation unit 230 outputs a message inducing the participant to purchase game points. Otherwise the game points of the participant are more than the minimum betting base amount of the selected betting game, the game operation unit 230 outputs a waiting screen of the selected betting game to the participants terminal. The process of checking the game points may be performed before the participant selects the betting game. In this case, the game operation unit 230 compares the game points of the participant with the minimum betting base amount among betting games that are selectable by the participant.

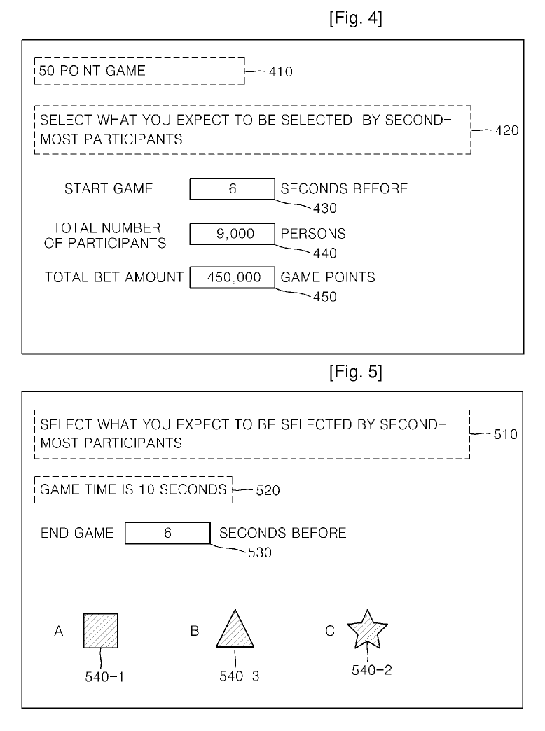

FIG. 4 illustrates a game waiting screen according to an exemplary embodiment.

Referring to FIG. 4, the game waiting screen includes a game title 410, a game mission 420, game start-time information 430, the total number of participants 440, and the total bet amount 450. The game title refers to a title of a game (e.g., a 50-point game) selected by the participants, and the game mission refers to a task assigned to participants of the selected game. Examples of the game mission may include Select what you expect to be selected by most participants, or Select what you expect to be selected by second-most participants. The game mission is randomly determined by the game operation unit 230 and presented to the participants. The game start-time information includes information on a remaining time until the time point when the game starts, i.e., a game start point. The remaining time refers to a time during which a game waiting time (e.g., 10 seconds, 20 seconds, 30 seconds, or 1 minute) set for a specific game expires from the time point when the first participant participates in the game. That is, the game waiting time refers to the remaining time until the gate start point. The game operation unit 230 provides, in real time, the user terminals 120-1 to 120-n of the game participants with the total number of participants and the total bet amount.

When the game waiting time expires, the game operation unit 230 provides a gaming screen to the user terminals 120-1 to 120-n of the participants participating in the game up to the corresponding time point. FIG. 5 illustrates the gaming screen output to the user terminals 120-1 to 120-n of the participants. Referring to FIG. 5, the gaming screen includes a game mission 510, a game time 520, a remaining time 530 until the time point when the game ends, i.e., a game end point, and selection objects 540-1 to 540-3. The game mission 510 is a task that is given to the game participants. In the gaming screen illustrated in FIG. 5, Select what you expect to be selected by second-most participants is presented as the game mission. The game time 520 is a temporal limitation on carrying out the game mission. Accordingly, as illustrated in FIG. 5, when the game time is set to 10 seconds, the participants must select one of the selection objects 540-1 to 540-3 displayed on the user terminals 120-1 to 120-n within 10 seconds. The participants select one of the selection objects 540-1 to 540-3 by using an input device such as a mouse or a keyboard. The game operation unit 230 stores, in the storage unit 220, identification information of the selection objects selected by the respective participants in connection with the member information of the participants selecting the corresponding objects. The remaining time 530 until the game end point is counted from the game start point.

The selection objects 540-1 to 540-3 may be configured in a form of pictures, moving images, or characters. The selection objects 540-1 to 540-3 have inherent identification information. For example, the selection objects 540-1 to 540-3 may be presented in a shape of a quadrangle, a triangle, and a star, respectively, or may be presented by allocating characters such as A(540-1), B(540-2), and C(540-3) to the respective pictures. The selection objects may be set to celebrities, products, or titles of broadcasting programs, so that preferences of the participants can be determined, or an opinion poll on specific affairs can be conducted. Furthermore, since each participant carrying out the game mission also considers choices of other participants, a new type of research can be conducted by using this system for researching opinions of users before a new product, game or service is released. When the game waiting time expires, the game operation unit 230 blocks participation of other users in the corresponding game. A different session is offered to the users who access the betting-game providing system 100 after the lapse of the game waiting time.

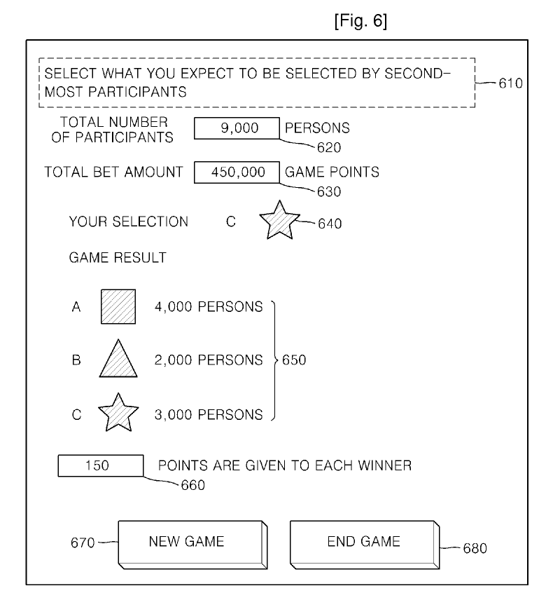

When the game is over, that is, the remaining time until the game end point becomes zero, the game operation unit 230 provides a game result screen to the user terminals 120-1 to 120-n of the participants and then ends the game. FIG. 6 illustrates the game result screen according to an exemplary embodiment. Referring to FIG. 6, the game result screen includes a game mission 610, the total number of participants 620, the total bet amount 630 wagered on the game, selection object information 640 about the selection object selected by the corresponding participant, game result information 650, the dividend 660, a new game button 670, and an end game button 680. The game mission 610 is a task that is set for the game selected by the participants. The total number of participants 620 is the number of participants participating in the corresponding game at the game start point, and the total bet amount 630 is the total amount wagered on the game. The selection object information 640 is information about the selection object selected by the corresponding participant. The game result information 650 is information about the number of participants selecting the respective selection objects 540-1 to 540-3 and information about the selection object 540-3 matching with the given game mission. The dividend 660 is calculated by the dividend calculation unit 240. The participant chooses whether to continue the game or end the game by selecting the new game button 670 or the end game button 680.

The dividend calculation unit 240 calculates the dividend to be paid to each participant accomplishing the given game mission, on the basis of the sum of bet amounts of the game participants at the game start point, and the number of participants accomplishing the given mission at the game end point. The dividend calculation unit 240 adds the calculated dividend to the game points of each participant accomplishing the game mission. Referring to FIG. 6, 3000 out of total 9000 participants select the selection object C(540-3), and therefore the selection object C(540-3) is one that is selected by the second-most participants. Thus, the dividend is 150 points.

In the above exemplary embodiment, the betting-game providing system 100 may send a screen associated with a game via a broadcast network. One or more viewers who want to participate in the game may access an automatic response service (ARS) system using respective wired/wireless phones, and participate in the game according to instructions from the ARS system. The ARS system may be embedded into the betting-game providing system 100 or may be separately provided, and serves as the game operation unit 230. In this case, selection objects, a participation period, and an ARS number are displayed on a broadcast screen. The participation period is the period of time from the game start point to the game end point, for example, from 8:00 p.m. to 10:00 p.m. The viewers can participate in the game according to instructions from the ARS system connected using wired/wireless phone within the given participation time. The result of the game may be displayed on the broadcast screen or the mobile communication terminal of each participant in a form of a text or voice message.

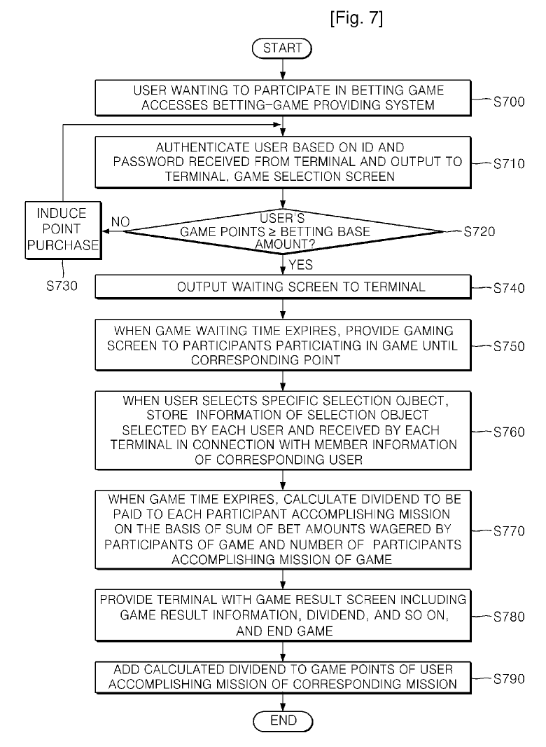

FIG. 7 is a flowchart illustrating a method for providing a betting game according to an exemplary embodiment.

Referring to FIG. 7, in step S700, users who want to participate in the betting game access the betting game system 100 via the communication network 110 by using their own terminals 120-1 to 120-n. In step S710, the betting-game providing system 100 authenticates the users on the basis of member IDs and passwords received from the user terminals 120-1 to 120-n, and then outputs a game selection screen to the user terminals 120-1 to 120-n. The game selection screen includes a plurality of game selection buttons, a point purchase button, and game points of the corresponding participant. In step S720, when the user selects a specific game, the betting-game providing system 100 checks whether the game points of the participant are more than a minimum betting base amount of the selected game. In step S730, when the game points of the participant are less than the minimum betting base amount of the selected game, the betting-game providing system 100 outputs a message inducing the participant to purchase game points to the use terminals 120-1 to 120-n. In step 740, when the game points of the participant are more than the minimum betting base amount of the selected game, the betting-game providing system 100 outputs a waiting screen to the user terminals 120-1 to 120-n. The waiting screen includes a game title of the selected betting game, a game mission, game start time information, the total number of participants at the point when the user participates in the game, and the total bet amount at the point when the user participates in the game.

In step S750, when the game waiting time expires, the betting-game providing system 100 provides a gaming screen to user terminals 120-1 to 120n of participants who have participated in the game up to that point. The gaming screen includes a game mission, a game time, a remaining time until the game end point, and selection objects. In step S760, when the participants select the specific selection object by using the user terminals 120-1 to 120-n, the betting-game providing system 100 stores, in a storage unit, identification information of the selected selection object in connection with member information of the participants selecting the corresponding selection object. In step S770, when the betting game starting while providing the gaming screen is over, that is, the remaining time until the game end point becomes zero, the betting-game providing system 100 calculates a dividend to be paid to each participant accomplishing the given game mission on the basis of the sum of bet amounts wagered by the game participants at the game start point, and the number of participants accomplishing the given game mission of the betting game at the game end point. In step S780, the betting-game providing system 100 provides the user terminals 120-1 to 120-n with a game result screen including the game mission, the total number of participants, the total bet amount, information of the selection object selected by the corresponding participant, game result information, the dividend, a new game button, and an end game button. In operation 790, the betting-game providing system 100 adds the calculated dividend to game points of each participant accomplishing the given game mission of the betting game.

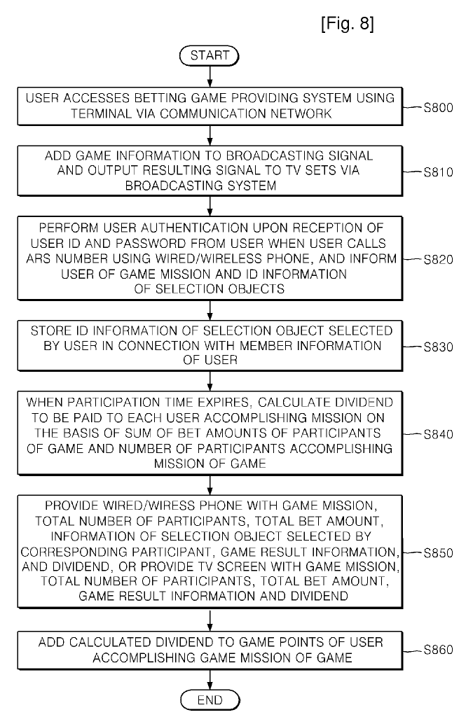

FIG. 8 is a flowchart illustrating a method for providing a betting game according to another exemplary embodiment.

Referring to FIG. 8, in step S800, the betting-game providing system 100 adds game information on a broadcasting signal and sends a resulting signal to TV sets 120-1 to 120-n through a broadcasting system. The game information includes a game mission, a participation period, and an ARS number. The broadcasting system adds the game information provided from the betting-game providing system 100 on a broadcasting signal, and thus sends the game information as a broadcasting signal. In step S810, the betting-game providing system 100 provides in real time the broadcasting system with the total number of participants of the betting game and the total bet amount wagered on the game, so that the TV viewers can be informed of a progress status of the game.

In step S820, when at least one user who wants to participate in the game calls the ARS number displayed on a TV screen by using a wired/wireless phone, the betting-game providing system 100 receives a user ID and a password from the user, authenticates the user, and then informs the user of a game mission and identification information of selection objects. To this end, the betting-game providing system 100 includes an ARS system. Alternatively, the ARS system may operate separately from the betting-game providing system 100, and runs the betting game through data exchange with the betting-game providing system 100. The user authentication may be selectively performed. In step S830, the betting-game providing system 100 stores in a storage unit, information of the selected selection object in connection with identification information of the user, i.e., user ID, telephone number of the user, etc.

In step S840, when the participation period expires, the betting-game providing system 100 calculates a dividend to be paid to each participant accomplishing the given game mission on the basis of the sum of bet amounts wagered on the betting game by the participants and the number of participants accomplishing the given game mission. In step S850, the betting-game providing system 100 provides the game mission, the total number of participants, the total bet amount, information of the selection object selected by the user, game result information, and the dividend through the wired/wireless phone of the users, or displays the game mission, the total number of participants, the total bet amount, the game result information, and the dividend on the TV screen. In step 860, the betting-game providing system 100 adds the calculated dividend to game points of each participant accomplishing the given game mission of the game.

In the system and method for providing the betting game via the communication network according to the exemplary embodiments, game participants simultaneously accessing the betting-game providing system on the network make a bet on a future result (e.g., how many times each of the selection objects is selected by the participants of the betting game) to be determined by collecting selections of the game participants, i.e., selections from the given selection objects by the participants. Then, a dividend is paid to each game participant meeting a winning condition, i.e., condition for receiving the dividend, which is presented before the participants make selection of the selection objects.

The present invention may be realized as computer-readable codes recorded on a computer-readable recording medium. The computer-readable recording medium may include all types of recording devices storing computer-readable data. Examples of the computer-readable recording medium may include a read only memory (ROM), a random access memory (RAM), a CD-ROM, a magnetic tape, a floppy disk, an optical data storage, and the like. The computer-readable recording medium may be implemented as a carrier wave. Also, the computer-readable recording medium may be distributed among computer systems interconnected through a network, and computer-readable codes may be stored and executed in the distributed system.

Although the system and method for providing the betting game via the communication network have been described with reference to the specific embodiments, they are not limited thereto. Therefore, it will be readily understood by those skilled in the art that various modifications and changes can be made thereto without departing from the spirit and scope of the present invention defined by the appended claims.

1. A system for providing a betting game via a communication network, comprising:
a game operation unit configured to provide at least one user terminal accessing via a communication network with one or more of a game selection screen, a game waiting screen, a gaming screen, and a game result screen, wherein, the game selection screen includes a plurality of selection buttons for allowing the user to select betting games classified according to a betting base amount, the game waiting screen is provided when a user of the user terminal selects a desired betting game, the game waiting screen comprising a game mission set for the selected betting game, a remaining time until a game start point, a total number of participants participating in the betting game until the point when the user selects the betting game, and a total bet amount wagered until the point when the user selects the betting game, the gaming screen is provided when the remaining time until the game start point expires, the gaming screen comprising a remaining time until a game end point, and a plurality of selection objects, each of which comprises identification information, and the game result screen is provided when the remaining time until the game end point expires, the game result screen comprising a total number of participants, the total bet amount, the selection object selected by the user, a number of participants that have selected each of the selection objects, and a dividend to be given to each participant who has selected the selection object corresponding to the game mission;
a dividend calculation unit configured to calculate the dividend to be given to each participant who selects the selection object corresponding to the game mission, on the basis of the sum of bet amounts wagered by the total number of participants of the betting game, and the number of participants selecting the selection object corresponding to the game mission; and
a storage unit configured to store screen composition information of the betting game, identification information of the selection objects selected by the participants of the betting game, the identification information of the selection objects corresponding to identification information of the respective participants who select the corresponding selection objects, and the number of participants and the total bet amount of the betting game.

2. The system of claim 1, further comprising a member management unit configured to authenticate the user on the basis of a member identification (ID) and a password input by the user through the user terminal accessing the system via the communication network and to manage game points of the authenticated user, wherein the game operation unit provides the user terminal with the game waiting screen, upon the successful authentication of the user, when the game points of the authenticated user are more than a betting base amount set for the betting game selected by the user.

3. The system of claim 1, wherein the selection object is provided in a form of at least one of a picture, a moving picture, and a character, to which identification information is assigned, and the game mission relates to ranking of how many times each of the selection objects is selected by the participants of the betting game.

4. A system for providing a betting game via a communication network, comprising:
a game operation unit configured to provide a broadcasting signal transmitter with game information about a betting game, the game information comprising a plurality of selection objects, a participation period, and an automatic response service (ARS) number, to receive identification information of the selection objects selected by one or more participants accessing an ARS system corresponding to the ARS number using wired/wireless communication devices within the participation period, and to provide the broadcasting signal transmitter or the wired/wireless communication devices of the respective participants with game result information when the participation period expires, the game result information comprising the total number of participants of the betting game, the total bet amount, the number of participants selecting the selection objects, and a dividend to be given to each participant selecting the selection object corresponding to the game mission;
a dividend calculation unit configured to calculate the dividend to be given to each participant selecting the selection object corresponding to the game mission on the basis of the sum of bet amounts wagered by the participants of the betting game, and the number of participants selecting the selection object corresponding to the game mission; and
a storage unit configured to store game information of the betting game, identification information of the selection objects selected by the participants of the betting game, the identification information of the selection objects being in connection with identification information of the respective participants selecting the corresponding selection objects, and the total number of participants and the total bet amount of the betting game.

5. The system of claim 4, wherein the broadcasting signal transmitter adds the game information and the game result information to a broadcasting signal and transmits a resultant signal.

6. A method for providing a betting game via a communication network, comprising:
providing at least one user terminal accessing via a communication network with a game selection screen for allowing a user to select betting games classified according to a betting base amount;
providing the user terminal with a game waiting screen when a user of the user terminal selects a desired betting game, the game waiting screen comprising a game mission set for the betting game selected by the user, a remaining time until a game start point, the total number of participants participating in the betting game until the point when the user selects the betting game, and the total bet amount wagered until the point when the user selects the betting game;
providing the user terminal with a gaming screen when the remaining time until the game start point expires, the gaming screen comprising a remaining time until a game end point, and a plurality of selection objects each having identification information;
calculating a dividend to be given to each participant selecting the selection object corresponding to the game mission on the basis of the sum of bet amounts wagered by participants of the betting game, and the number of participants selecting the selection object corresponding to the game mission, when the remaining time until the game end point expires; and
providing the user terminal with a game result screen when the time reaches the game end point, the game result screen comprising the total number of participants, the total bet amount, the selection object selected by the user, the numbers of participants selecting each of the selection objects, and the dividend to be given to each participant selecting the selection object corresponding to the game mission.

7. The method of claim 6, further comprising: authenticating the user on the basis of a member identification (ID) and a password input by the user through the user terminal; and providing the user terminal with the game waiting screen upon the successful authentication of the user, when game points of the authenticated user are more than a betting base amount set for the betting game selected by the user.

8. The method of claim 6, wherein the selection object is at least one of a picture, a moving picture, and a character, to which identification information is assigned, and the game mission relates to ranking of how many times each of the selection objects is selected by the participants of the betting game.

9. A method for providing a betting game via a communication network, comprising:
providing a broadcasting signal transmitter with game information of a betting game, the game information comprising a plurality of selection objects, a participation period, and an automatic response service (ARS) number;
receiving identification information of the selection objects selected by one or more participants accessing a ARS system corresponding to the ARS number using wired/wires communication devices within the participation period;
calculating a dividend to be given to each participant selecting the selection object corresponding to the game mission on the basis of the sum of bet amounts wagered by the participants of the betting game, and the number of participants selecting the selection object corresponding to the game mission, when the participation time expires; and
providing the broadcasting signal transmitter or the wired/wireless communication devices of the respective participants with game result information when the participation time expires, the game result information comprising the total number of participants of the betting game, the total bet amount, the numbers of participants selecting each of the selection objects, and the dividend to be given to each participant selecting the selection object corresponding to the game mission.

10. The method of claim 9, wherein the broadcasting signal transmitter adds the game information and the game result information to a broadcasting signal, and transmits a resultant signal.

11. A computer-readable recording medium storing a computer-readable program for executing the method of claim 6.

12. A computer-readable recording medium storing a computer-readable program for executing the method of claim 9.
